(19) United States
(12) Patent Application Publication
(10) Pub. No.: US 2012/0169214 A1
(43) Pub. Date: Jul. 5, 2012

(54) NANO-SIZED PHOSPHOR, EMITTING LAYER INCLUDING THE SAME, INORGANIC LIGHT EMITTING DEVICE INCLUDING EMITTING LAYER, METHOD OF PREPARING NANO-SIZED PHOSPHOR, AND METHOD OF PREPARING EMITTING LAYER

(75) Inventors: Shang-hyeun PARK, Yongin-si (KR); Tae-won JEONG, Yongin-si (KR); Min-jong BAE, Yongin-si (KR)

(73) Assignee: SAMSUNG ELECTRONICS CO., LTD., Suwon-si (KR)

(21) Appl. No.: 13/244,130

(22) Filed: Sep. 23, 2011

(30) Foreign Application Priority Data
Jan. 4, 2011 (KR) 10-2011-0000552

(51) Int. Cl. H01J 1/63; C09K 11/84; B05D 5/06; B32B 5/16; C09K 11/56

(52) U.S. Cl. 313/503; 428/402; 252/301.4 S; 427/162

(57) ABSTRACT

A nano-sized phosphor including: sulfur, wherein the nano-sized phosphor has a mean largest particle diameter of less than 1 micrometer.

### CROSS-REFERENCE TO RELATED APPLICATIONS

This application claims priority to Korean Patent Application No. 10-2011-0000552, filed on Jan. 4, 2011, and all the benefits accruing therefrom under 35 U.S.C. §119, the content of which in its entirety is herein incorporated by reference.

### BACKGROUND

(1). Field

The present disclosure relates to a nano-sized phosphor, an emitting layer including the nano-sized phosphor, an inorganic light-emitting device including the emitting layer, a method of preparing the nano-sized phosphor, and a method of preparing the emitting layer.

(2). Description of the Related Art

Light-emitting devices may be classified as an organic light-emitting device including an emitting layer having an organic phosphor, or an inorganic light-emitting device including an emitting layer having an inorganic phosphor.

Inorganic light-emitting devices may be used in various applications such as in display devices, light sources, and the like. Inorganic light-emitting devices may be classified as a thin film inorganic light-emitting device or as a dispersive inorganic light-emitting device. An emitting layer of a thin film inorganic light-emitting device may be formed by a deposition method, a sputtering method, or the like. Unlike a thermionic emitter that may have a subtle turn-on voltage, the thin film inorganic light-emitting device may have an obvious (e.g., discontinuous or discrete) threshold voltage for emission. The manufacturing costs of thin film inorganic light-emitting device may be relatively high, and a material for forming the emitting layer may be in limited supply. However, an emitting layer of a dispersive inorganic light-emitting device may include a phosphor that is dispersed in a matrix including a binder resin, may be prepared by a simple preparation method at low cost, and may provide a flexible light-emitting device when disposed on a flexible substrate. Thus, the dispersive inorganic light-emitting device has been actively developed for application as a light source, e.g., a lamp, for cellular phone keypads, billboards, medical equipment, or the like. Nonetheless, there remains a need for an improved phosphor, and an improved emitting layer including the phosphor.

### SUMMARY

Provided is a nano-sized phosphor including sulfur (S), an emitting layer including the nano-sized phosphor, and an inorganic light-emitting device including the emitting layer.

Also provided are methods of preparing the nano-sized phosphor, and methods of preparing the emitting layer.

Additional aspects, advantages, and features will be set forth in part in the description which follows and, in part, will be apparent from the description.

According to an aspect, disclosed is a nano-sized phosphor including sulfur, wherein the nano-sized phosphor has a mean largest particle diameter of less than 1 micrometer (μm).

According to another aspect, disclosed is an emitting layer including the nano-sized phosphor and a binder.

According to another aspect, disclosed is an inorganic light-emitting device including a first electrode; a dielectric layer; an emitting layer including the nano-sized phosphor and a binder; and a second electrode.

According to another aspect, a method of preparing a nano-sized phosphor includes: contacting a first phosphor including sulfur (S) and a first solvent to prepare a first mixture; pulverizing the first mixture to prepare a second mixture including a pulverized first phosphor and the first solvent; removing the first solvent from the second mixture to obtain the pulverized first phosphor; and heat-treating the pulverized first phosphor under a reducing atmosphere to prepare the nano-sized phosphor, wherein the nano-sized phosphor has a same composition as a composition of the first phosphor, a particle of the nano-sized phosphor has a mean largest particle diameter of less than 1 micrometer, and the nano-sized phosphor particle includes sulfur (S).

According to another aspect, a method of preparing an emitting layer includes providing a composition including; a nano-sized phosphor including sulfur, wherein a particle of the nano-sized phosphor has a mean largest particle diameter of less than 1 micrometer, a binder, and a solvent; disposing the composition on a substrate; and heat-treating the composition on the substrate to prepare the emitting layer including the nano-sized phosphor and the binder.

### BRIEF DESCRIPTION OF THE DRAWINGS

These and/or other aspects, advantages, and features of this disclosure will become apparent and more readily appreciated from the following description of the embodiments, taken in conjunction with the accompanying drawings, in which:

FIG. 1 is a schematic cross-sectional view of an embodiment of an inorganic light-emitting device;

FIG. 2 is a scanning electron micrograph (“SEM”) of an embodiment of a BaAl₂S₄:Eu bulk phosphor used as a first phosphor in Example 1;

FIGS. 3A and 3B are SEMS of an embodiment of a pulverized BaAl₂S₄;Eu bulk phosphor of Example 1;

FIGS. 4A and 4B are SEMS of an embodiment of a BaAl₂S₄:Eu nano-sized phosphor of Example 1;

FIG. 5 is a graph illustrating intensity (arbitrary units) versus diffraction angle (degrees two theta, 2θ) and shows X-ray diffraction (“XRD”) patterns of the BaAl₂S₄:Eu bulk phosphor, the pulverized BaAl₂S₄:Eu bulk phosphor, the BaAl₂S₄:Eu nano-sized phosphor of Example 1, and the BaAl₂S₄:Eu nano-sized phosphor of Example 2;

FIG. 6A, FIG. 6B, FIG. 6C, and FIG. 6D are graphs of intensity (arbitrary units) versus diffraction angle (degrees two theta, 2θ) showing enlarged views of peaks of FIG. 5 at a diffraction angle (2 theta) from about 22.0 to about 25.0 degrees two theta in the XRD patterns of the BaAl₂S₄:Eu bulk phosphor, the pulverized BaAl₂S₄:Eu bulk phosphor, the BaAl₂S4:Eu nano-sized phosphor of Example 1, and the BaAl₂S₄:Eu nano-sized phosphor of Example 2, respectively; and

FIG. 7 is a graph illustrating intensity (arbitrary units) versus wavelength (nanometers, nm) showing the luminescent properties of the BaAl₂S₄:Eu bulk phosphor and the BaAl₂S₄:Eu nano-sized phosphor of Example 1.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting, As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Reference will now be made in further detail to the disclosed embodiments.

A mean largest particle diameter of the nano-sized phosphor is less than about 1 micrometer (μm).

As used herein, the term “nano-sized” means that a mean largest particle diameter of a nano-sized phosphor is less than 1 μm. The mean largest particle diameter may be determined by viewing (e.g., analyzing) a scanning electron micrograph (“SEM”) of the phosphor. For example, when mean largest particle diameter of a phosphor, when determined by analysis of the SEM, is less than 1 μm, the phosphor may be referred to as a nano-sized phosphor. A minimum value of the mean largest particle diameter of the nano-sized phosphor may be 0.1 nanometers (nm), but is not limited thereto.

For example, the mean largest particle diameter of the nano-sized phosphor may be in the range of about 100 nm to about 900 nm, specifically about 200 nm to about 800 nm, more specifically about 300 nm to about 700 nm. In an embodiment, the mean largest particle diameter of the nano-sized phosphor may be in the range of about 200 nm to about 800 nm, but is not limited thereto. The mean largest particle diameter of the nano-sized phosphor may be variously determined according to a method of preparing the nano-sized phosphor.

The nano-sized phosphor may have various shapes. In an exemplary embodiment, the nano-sized phosphor may comprise a particle having at least one selected from an oval shape, a triangular shape, a square shape, a circular shape, a peanut shape, or a spherical shape, and a largest protrusion of a surface of the nano-sized phosphor comprises a dimension which is less than 50% of the mean largest particle diameter of the nano-sized phosphor.

“Smooth” means that there is substantially or essentially no protrusion on a surface of a phosphor particle. For example, the nano-sized phosphor having a smooth surface may be contrasted with a bulk phosphor having a protrusion on a surface thereof and having the same composition as that of the nano-sized phosphor. The presence of a protrusion may be determined by comparing SEMS of the nano-sized phosphor and the bulk phosphor. A protrusion on a surface of a particle of the nano-sized phosphor may comprise a dimension (e.g., a height, wherein the height is in a direction perpendicular to a surface of the particle) which is less than 50%, specifically less than 40%, more specifically less than 30%, or 1 to 50%, or 3 to 40% or 6 to 30% of the mean largest particle diameter of the phosphor particle.

The nano-sized phosphor may have various compositions and may comprise, for example, sulfur (S). In addition, oxygen (O) may not be substantially included in the nano-sized phosphor. Without being bound by a particular theory, it is believed the nano-sized phosphor may be effectively prevented from being oxidized when the nano-sized phosphor is prepared by a preparation method according to an embodiment, which will be further disclosed below.

The nano-sized phosphor may be a blue phosphor. In an embodiment, the nano-sized phosphor may further include a dopant. The dopant may be at least one selected from europium (Eu) and cerium (Ce), but is not limited thereto.

In an embodiment, the nano-sized phosphor may have a composition represented by Formulas 1 or 2:

(M₁)(M₂)₂S₄:Eu Formula 1

(M₃)S:Ce Formula 2

In Formulas 1 and 2, M₁ and M₃ are each independently at least one selected from beryllium (Be), magnesium (Mg), calcium (Ca), strontium (Sr), barium (Ba), and radium (Ra), and M₂ is at least one selected from of boron (B), aluminum (Al), gallium (Ga), indium (In), and thallium (Tl).

In an embodiment, the nano-sized phosphor may have a composition selected from BaAl₂S₄:Eu, and SrS:Ce, but is not limited thereto. In an embodiment, the nano-sized phosphor has a composition selected from BaAl₂S₄:Eu, SrGa₂S₄:Eu, and SrS:Ce.

A method of preparing the nano-sized phosphor is further disclosed below.

A first phosphor comprising sulfur and a first solvent for preventing the first phosphor from being oxidized are combined to prepare a first mixture.

The first phosphor is a bulk phosphor having essentially or substantially the same composition as that of the nano-sized phosphor. The first phosphor may have a mean largest particle diameter of, for example, about 1 μm or more, specifically about 3 μm or more, more specifically about 6 μm or more, but is not limited thereto. In an embodiment, the first phosphor has a mean lamest particle diameter of about 1 to about 100 μm, specifically about 2 to about 80 μm, more specifically about 4 to about 60 μm. The first phosphor may have various shapes, and may have, for example, an amorphous shape having a protrusion disposed on a surface thereof. The size, shape, and the like of the first phosphor may be determined by analysis of an SEM of the first phosphor.

Without wanting to be bound by theory, although the first phosphor has the same composition as that of the nano-sized phosphor, because of the first phosphor's size and shape, the first phosphor may be non-uniformly dispersed when combined with a binder and solvent. The combination of the first phosphor, binder, and solvent may be used to make an emitting layer. However, a device that includes such an emitting layer may have defective electrical properties because of the low degree of dispersion of the first phosphor in the binder and solvent and the relatively high degree of surface roughness of the emitting layer made from the first phosphor.

The first solvent, which is combined with the first phosphor to provide the first mixture, may be effectively or substantially inert towards the first phosphor and may substantially or effectively prevent the first phosphor from bend oxidized.

The first solvent may have a viscosity of about 2 milliPascal-seconds (mPas) to about 12 mPas, specifically about 3 mPas to about 11 mPas, more specifically about 4 mPas to about 10 mPas at a temperature of 25° C. In an embodiment, the first solvent may be octanol, which has a viscosity of 5 mPas at a temperature of 25° C. For comparison, water has a viscosity of 0.894 mPas at a temperature of 25° C., and ethanol has a viscosity of 1.074 mPas at 25° C. Thus, the first solvent has a relatively high viscosity. If the viscosity of the first solvent is in the above range, when the first phosphor is pulverized, impacts applied to the first phosphor may be appropriately controlled by a pulverizer (e.g., beads of a ball mill), and a crystalline structure of the first phosphor may be minimally damaged.

The first solvent may have an oxygen content of less than about 20 weight percent (wt %), specifically less than 15 wt %, more specifically about 1 to about 18 wt %, based on the total molecular weight of the solvent. The oxygen content (e.g., wt %) of the first solvent may be calculated according to the equation:

Oxygen wt %=(oxygen atomic weight in the first solvent/total molecular weight of the first solvent)*100%

For example, octanol has an oxygen content of 12.28 wt % (oxygen atomic weight in octanol (15.99 g/mol)/molecular weight of octanol (130.23 g/mol)*100). If the oxygen content of the first solvent is in the above range when the first phosphor is pulverized, the first phosphor may be substantially prevented from being oxidized, and the first phosphor may have the same composition as that of the nano-sized phosphor described below.

The first solvent may simultaneously have a viscosity and an oxygen content in the above ranges. In an embodiment, the first solvent may comprise a C₇ or higher linear or branched alcohol. In another exemplary embodiment, the first solvent may comprise a C₇ to C₂₀ linear or branched alcohol. In yet another exemplary embodiment, the first solvent may comprise a C₇ to C₁₀ linear or branched alcohol, but is not limited thereto.

In an embodiment, the first solvent may be at least one selected from 1-heptanol, 2-heptanol, 3-heptanol, 4-heptanol, 1-octanol, 2-octanol, 3-octanol, 4-octanol, 1-nonanol, 2-nonanol, 3-nonanol, 4-nonanol, 5-nonanol, 1-decanol, 2-decanol, 3-decanol, 4-decanol, and 5-decanol, but is not limited thereto.

The first phosphor in the first mixture is pulverized to prepare a second mixture comprising a pulverized first phosphor and the first solvent.

Since the first phosphor is pulverized in the presence of the first solvent, which prevents oxidation of the first phosphor in the first mixture, the first phosphor may be substantially prevented from being oxidized during the pulverization of the first phosphor. The first phosphor in the first mixture may be pulverized by a commercially available pulverization method such as ball milling, or the like.

Then, in order to prevent the first phosphor from being oxidized, the pulverized first phosphor may be obtained (e.g., separated) from the second mixture by a separation process such as freeze-drying.

The pulverized first phosphor may be obtained from the second mixture by contacting the second mixture with a second solvent that is removable in the freeze-drying process. The second mixture is contacted with the second solvent to remove the first solvent included in the second mixture, and then the second solvent is removed in the freeze-drying process.

The second solvent may be removable from the second mixture by freeze-drying process, and may also be mixed with the first solvent. The second solvent may be, for example, an alcohol, but is not limited thereto. In an embodiment, the second solvent may be at least one selected from ethanol, and isopropyl alcohol, and the like.

Conditions for freeze-drying may vary according to the second solvent. In an embodiment, the freeze-drying process may be performed for about 0.5 hours to about 24 hours, specifically about 1 hours to about 22 hours, more specifically about 1.5 hours to about 20 hours at a temperature of about −20° C. to about −3° C., specifically of about −15° C. to about −5° C., more specifically of about −10° C.

The pulverized first phosphor may comprise a minute particle having substantially the same composition as that of the first phosphor. The mean largest particle diameter of the minute particle may be several tens of nanometers (nm). In addition, the pulverized first phosphor may include an amorphous particle having substantially the same composition as that of the first phosphor.

Then, the pulverized first phosphor may be heat-treated in a reducing atmosphere to prepare the nano-sized phosphor. The nano-sized phosphor may have the same composition as that of the first phosphor, a mean largest particle diameter of less than 1 μm, and comprises sulfur (S).

The crystalline properties of the nano-sized phosphor may be improved by heat-treating the pulverized first phosphor. For example, an amorphous particle that may be included in the pulverized first phosphor may be crystallized during the heat-treatment.

A condition of the heat-treatment may vary according to a composition of the first phosphor, and the heat-treatment may be performed for about 0.5 hour to about 3 hours, specifically about 1 hour to about 2.5 hours, more specifically about 1.5 hours to about 2 hours, at a temperature of about 800° C. to about 1200° C., specifically 850° C. to about 1150° C., more specifically 900° C. to about 1000° C. When the conditions of the heat-treatment are in the above ranges, the pulverized first phosphor may be effectively crystallized.

The heat-treatment may be performed in a reducing atmosphere in order to prevent the pulverized first phosphor from being oxidized. The reducing atmosphere may comprise, for example, at least one selected from a sulfur-containing gas (for example, CS₂ gas), hydrogen gas, and nitrogen gas, but is not limited thereto. For example, the reducing atmosphere may be a CS₂ gas atmosphere. In this case, and while not wanting to be bound by theory, it is believed that under the CS₂ gas reducing atmosphere, even a slight loss in sulfur (S) of the pulverized first phosphor may be compensated for and thus the nano-sized phosphor having essentially or completely the same composition as the first phosphor may be provided.

According to the above-stated preparation method, the nano-sized phosphor, which has essentially or substantially the same composition as that of the first phosphor, may be easily obtained. The disclosed preparation method prevents undesirable oxidation of the first phosphor, and/or a product thereof, e.g., the pulverized first phosphor and/or the nano-sized phosphor.

In an embodiment, an emitting layer may include the nano-sized phosphor and a binder. The emitting layer is different from a thin film emitting layer formed by a deposition or sputtering method using a pallet or target having the same composition as that of the nano-sized phosphor since the emitting layer is a dispersive emitting layer in which the nano-sized phosphor is dispersed in a matrix comprising a binder.

A method of preparing the emitting layer is further disclosed below.

First, a composition for forming an emitting layer is prepared. The composition comprises the above-described nano-sized phosphor, a binder, and a solvent.

For the nano-sized phosphor and the method of preparing the same, reference may be made to the description provided in detail above.

The matrix may comprise the binder, and the nano-sized phosphor is dispersed in the matrix. The binder may comprise at least one polymer resin selected from a thermoplastic resin and a thermosetting resin. For example, the binder may comprise at least one selected from polycarbonate, cellulose, polycycloolefin, polyphenylene oxide, polysulfone, polyvinyl chloride, poly(methyl methacrylate), poly(phenylene ether), polyphenylene sulfide, polyether sulfone, polyether imide, polystyrene, polyethylene, polyvinylidene fluoride, an epoxy resin, a phenol resin, a siloxane resin, polyimide, an acryl resin, a cyanate resin (e.g., cyanoethylpullulan, cyanoethyl polyvinyl alcohol, and the like), benzocyclobutene, and a copolymer including at least two monomers from among these polymers. For example, the binder may be a copolymer formed by polymerizing monomers of cyanoethylpullulan and cyanoethyl polyvinyl alcohol, but is not limited thereto. A combination comprising at least one of the foregoing can be used. An amount of the binder may be about 10 to about 80 parts by weight, specifically about 12 to about 70 parts by weight, and more specifically, about 15 to about 65 parts by weight, based on 100 parts by weight of the nano-sized phosphor. When the amount of the binder is in the above range, the emitting layer may have excellent luminescent efficiency and properties.

The solvent in the composition may provide appropriate flow and viscosity for the composition for forming the emitting layer, and may be easily removed by a commercially available drying process. The solvent may be at least one selected from mesitylene, acetyl acetone, methyl-cyclohexanone, diisobutylketone, methyl phenyl ketone, dimethlysulfoxide, γ-butyrolactone, isophorone, diethylformamide, dimethylformamide, dimethylacetamide, N-methyl pyrrolidone, γ-butyrolactam, ethylene glycol acetate, 3-methoxy-3-methyl butanol and an acetate thereof, 3-methoxy butyl acetate, 2-ethylacetoacetate, an oxalic acid ester, diethyl malonate, maleic ester, propylene carbonate, butyl cellosolve, ethyl carbitol dimethylformamide, and chloroform, but the solvent is not limited thereto. An amount of the solvent may be about 200 to about 400 parts by weight, specifically about 225 to about 375 parts by weight, and more specifically about 250 to about 350 parts by weight, based on 100 parts by weight of the nano-sized phosphor. When the amount of the solvent is in this range, the composition for forming an emitting layer may comprise a relatively high amount of the nano-sized phosphor and binder to thus provide an emitting layer having excellent luminescent efficiency and properties.

The composition for forming the emitting layer may be disposed on a substrate.

The term “substrate” refers to a support, on which the emitting layer may be formed, and may be, for example, a surface for an inorganic light-emitting device or a surface of a dielectric material. The term “substrate” may be easily understood according to a structure of an exemplary embodiment.

The composition for forming an emitting layer may be disposed by using a commercially available method, for example, a method selected from spin coating, casting, inkjet printing, dip coating, and laser printing, and the like.

After the composition for forming an emitting layer is disposed on the substrate, the composition is heat-treated to prepare the emitting layer comprising the nano-sized phosphor and the binder.

At least a portion of the solvent is removed from the composition during formation of the emitting layer on the substrate by the heat-treatment. If desirable, cross-linking of the binder, or the like, may be optionally also performed to form the emitting layer. The heat-treatment process may be selected from various methods according to the type of the binder and the solvent.

According to an embodiment, an inorganic light-emitting device comprises a substrate, a first electrode, a dielectric layer, an emitting layer comprising the nano-sized phosphor and the binder, and a second electrode. The inorganic light-emitting device comprises a dispersive emitting layer comprising the nano-sized phosphor and the binder. Thus, the inorganic light-emitting device may have excellent electrical properties and may be part of a flexible device. In addition, the inorganic light-emitting device may be prepared by using a simple preparation method at low cost.

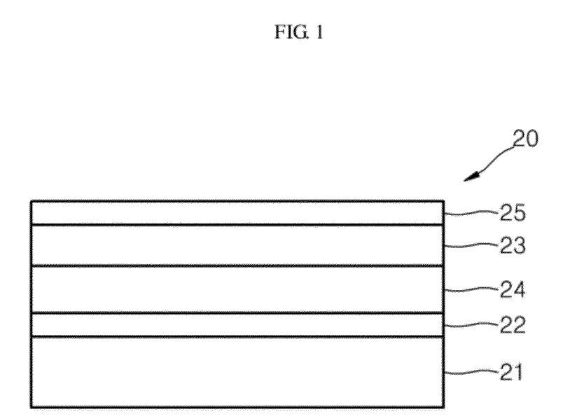

FIG. 1 is a schematic cross-section of an embodiment of an inorganic light-emitting device 20. The inorganic light-emitting device 20 includes a first electrode 21, a first dielectric layer 22, an emitting layer 24, a second dielectric layer 23, and a second electrode 25.

Although not illustrated in FIG. 1, the first electrode 21 is disposed (e.g., formed) on a substrate. The substrate may be a transparent substrate, and may be at least one selected from a glass substrate, and a plastic substrate, and the like, but is not limited thereto. The first electrode 21 may be a transparent electrode and may comprise a transparent conductive material such as indium tin oxide (“ITO”).

The first dielectric layer 22 is disposed (e.g., formed) on the first electrode 21. The first dielectric layer 22 may be formed by coating a composition including, for example, an inorganic dielectric particle, a binder, and a solvent on the first electrode 21 by using a commercially available coating method, such as screen-printing, and then heat-treating the composition. Examples of the inorganic dielectric particle may include titanium oxide (e.g., BaTiO₃), an antimony oxide, and a tin oxide, but are not limited thereto. For examples of the binder and the solvent, reference may be made to the description provided in further detail above, but are not limited thereto.

The emitting layer 24 is disposed (e.g., formed) on the first dielectric layer 22. For the emitting layer 24 and the method of preparing the same, reference may be made to the description provided in further detail above. Without wanting to be bound by theory, it is believed that emission occurs in the emitting layer 24 when an electron, accelerated by an electric field applied to the emitting layer 24, collides with a phosphor particle, causing excitation in the phosphor. Light of a particular wavelength (e.g., color) may be emitted by the excited phosphor particle based on the composition of the phosphor particle.

The second dielectric layer 23 is disposed (e.g., formed) on the emitting layer 24. For details of the second dielectric layer 23 and its production, reference may be made to the description of the first dielectric layer 22.

The second electrode 25 is disposed (e.g., formed) on the second dielectric layer 23. The second electrode 25 may comprise a transparent conductive material such as ITO, or a metal such as silver (Ag).

So far, the inorganic light-emitting device has been described with reference to FIG. 1. Various modifications may be made to the inorganic light-emitting device. As an example of a modification, the inorganic light-emitting device may comprise only one of the first dielectric layer 22 and the second dielectric layer 23.

Hereinafter, one or more embodiments are disclosed in further detail with reference to the following examples. However, these examples are not intended to limit the purpose and scope of the disclosed embodiments.

### EXAMPLES

### Example 1

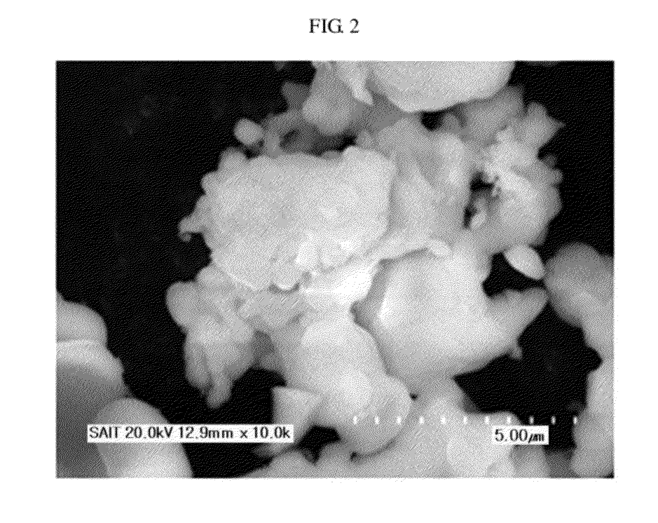

A first mixture formed by mixing 50 grams (g) of BaAl₂S₄:Eu bulk phosphor (available from Kojundo Chemical Laboratory Com. Ltd) with 450 g of 1-octanol was put into a ball mill (available from Kotobuki, Japan, model No.: UAM 015), and the first mixture was milled for 240 minutes at a mill frequency of 35 Hertz (Hz) and at a rate of 130 revolutions per minute (“rpm”) to obtain a second mixture including a pulverized BaAl₂S₄:Eu bulk phosphor and 1-octanol. FIG. 2 is a scanning electron micrograph of the BaAl₂S₄:Eu bulk phosphor. Referring to FIG. 2, it may be seen that the BaAl₂S₄:Eu bulk phosphor has a mean largest particle diameter of about 4 μm and is a shapeless amorphous particle having an uneven surface with a plurality of protrusions.

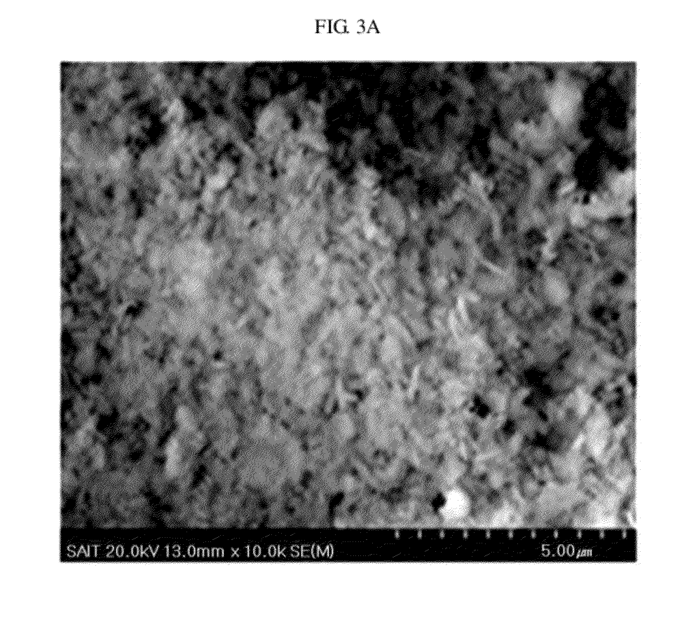

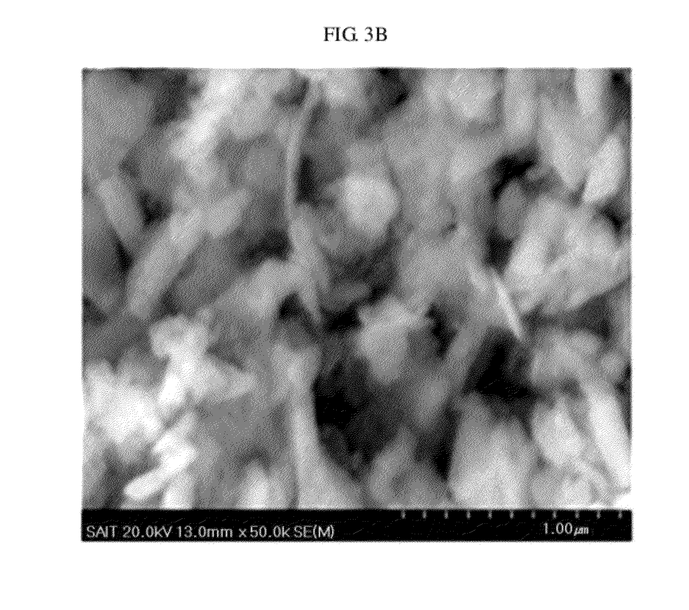

The 1-octanol was partially removed from the second mixture by freeze drying, and the second mixture was washed three times with 300 milliliters (mL) of ethanol to remove more of the 1-octanol. The second mixture was freeze-dried for and additional 24 hours at a temperature of −15° C. to remove the ethanol and to obtain the pulverized BaAl₂S₄:Eu bulk phosphor. FIG. 3A and FIG. 3B are scanning electron micrographs of the pulverized BaAl₂S₄:Eu bulk phosphor. FIG. 3B is a magnified view of a portion of FIG. 3A. Referring to FIG. 3A and FIG. 3B, it may be seen that the pulverized BaAl₂S₄:Eu bulk phosphor comprises a minute particle having a size (e.g., a mean largest particle diameter) of several tens of nanometers (nm).

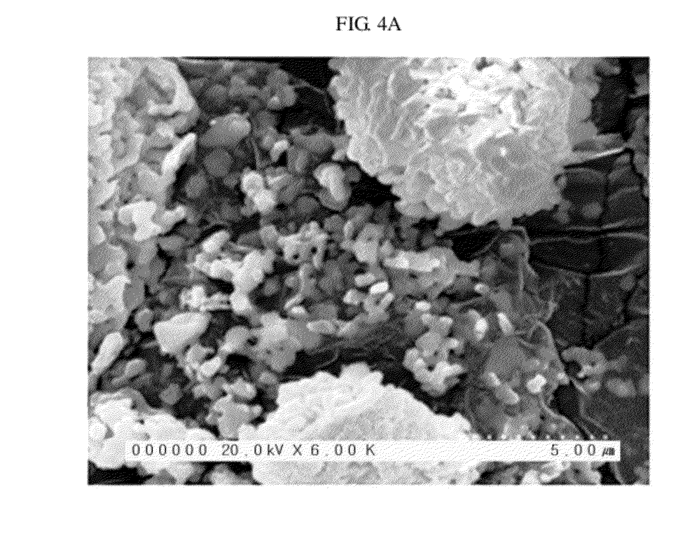

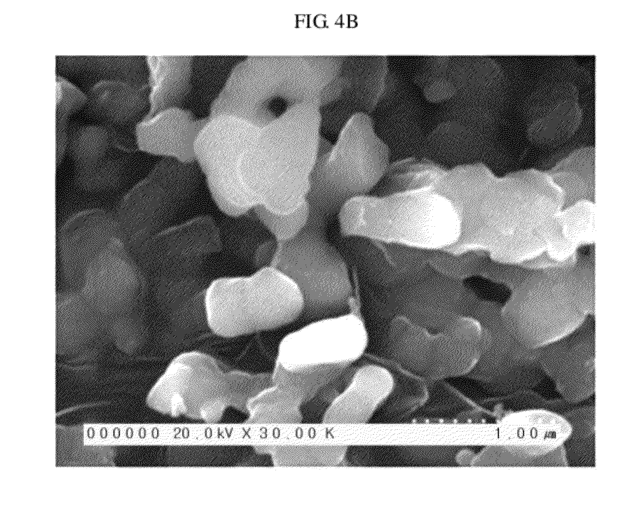

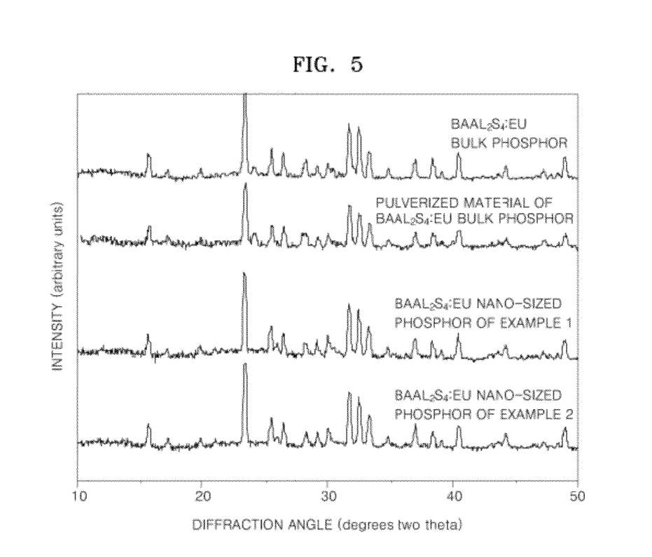

The pulverized BaAl₂S₄:Eu bulk phosphor was heat-treated for 2 hours at a temperature of 900° C. in a reducing atmosphere by flowing CS₂ gas at a flow rate of 150 cc/min to obtain the BaAl₂S₄:Eu nano-sized phosphor. FIG. 4A and FIG. 4B are scanning electron micrographs of the BaAl₂S₄:Eu nano-sized phosphor. FIG. 4B is a magnified view of a portion of FIG. 4A. Referring to FIGS. 4A and 4B, it may be seen that the BaAl₂S₄:Eu nano-sized phosphor has a mean largest particle diameter of about 800 nm and is a peanut-shaped particle having a smooth surface. A comparison of the BaAl₂S₄:Eu nano-sized phosphor in FIG. 4B with the BaAl₂S₄:Eu bulk phosphor in FIG. 2 illustrates that the nano-sized phosphor particles have smooth surfaces without surface protrusions that are characteristic of the bulk phosphor.

### Example 2

A BaAl₂S₄:Eu nano-sized phosphor was prepared in the same manner as in Example 1 except that the pulverized BaAl₂S₄:Eu bulk phosphor was heat-treated at a temperature of 1000° C.

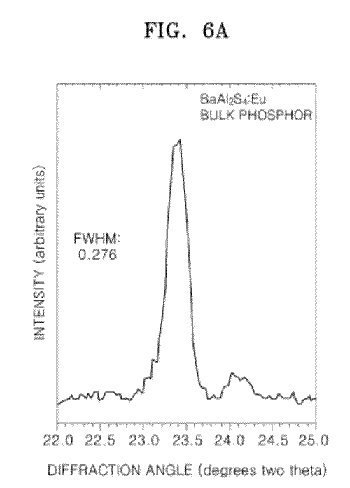

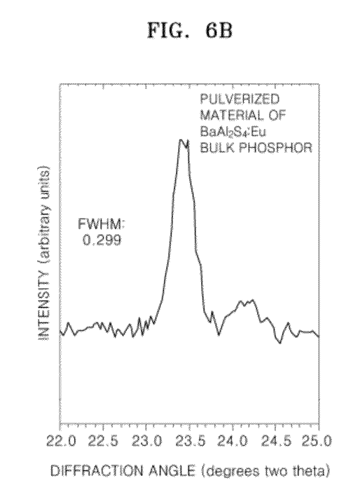

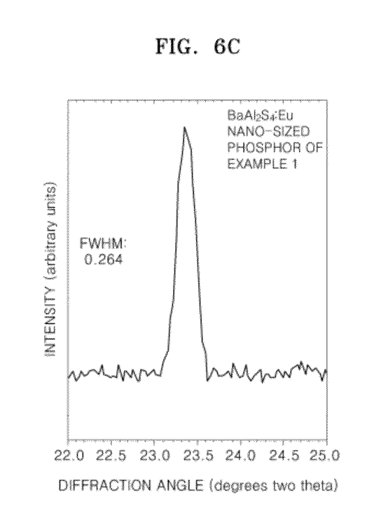

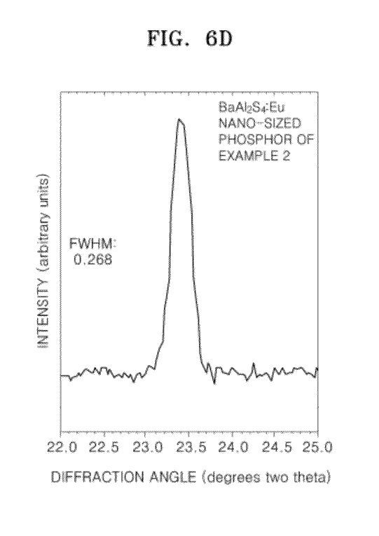

X-ray diffraction (“XRD”) patterns (XRD analysis was performed by using Philips XPert PRO) for the BaAl₂S₄:Eu bulk phosphor, the pulverized BaAl₂S₄:Eu bulk phosphor, the BaAl₂S₄:Eu nano-sized phosphor of Example 1, and the BaAl₂S₄:Eu nano-sized phosphor of Example 2 were acquired using the Ka1 line of a Cu anode of an X-ray diffractometer (Philips XPert PRO). The XRD spectra of the samples are shown in FIG. 5. FIG. 6A, FIG. 6B, FIG. 6C, and 6D are enlarged portions of the peaks at a diffraction angle (2 theta) from about 22.0 to about 25.0 degrees in the XRD spectra of the BaAl₂S₄:Eu bulk phosphor, the BaAl₂S₄:Eu bulk phosphor, the BaAl₂S₄:Eu nano-sized phosphor of Example 1, and the BaAl₂S₄:Eu nano-sized phosphor of Example 2, respectively. The full width at half maximum (“FWHM”) of each peak is shown to the left of the peak in FIGS. 6A, 6B, 6C, and 6D and are also shown in Table 1 below.

TABLE 1

| | FWHM of peak at diffraction |
|---|---|
| | angle (2 theta) from about |
| | 22.0 to about 25.0 |
| BaAl₂S₄: Eu bulk phosphor | 0.276 |
| Pulverized BaAl₂S₄: Eu bulk phosphor | 0.299 |
| BaAl₂S₄: Eu | 0.264 |
| nano-sized phosphor of Example 1 | |
| BaAl₂S₄: Eu | 0.268 |
| nano-sized phosphor of Example 2 | |

As shown in Table 1, the FWHM of the pulverized BaAl₂S₄:Eu bulk phosphor is 0.299 degrees and is greater than the FWHM of the BaAl₂S₄:Eu bulk phosphor, which is 0.276 degrees. Thus, the pulverized BaAl₂S₄:Eu bulk phosphor has a lower degree of crystallinity (i.e., includes amorphous particles) than the BaAl₂S₄:Eu bulk phosphor. Thus, the pulverized BaAl₂S₄:Eu bulk phosphor includes more amorphous particles than the non-pulverized bulk phosphor material.

The FWHM values of the BaAl₂S₄:Eu nano-sized phosphors of Example 1 and Example 2 (0.264 and 0.268 degrees, respectively) are less than the FWHM of the BaAl₂S₄:Eu bulk phosphor (0.276 degrees) and the FWHM of the pulverized BaAl₂S₄:Eu bulk phosphor (0.299 degrees). Thus, the BaAl₂S₄:Eu nano-sized phosphors of Examples 1 and 2 have excellent crystalline properties compared to the BaAl₂S4:Eu bulk phosphor and the pulverized BaAl₂S₄:Eu bulk phosphor.

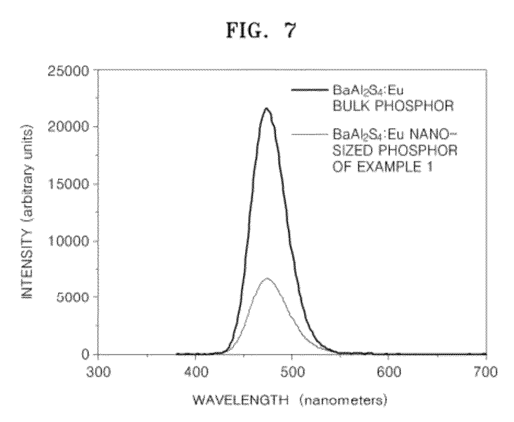

Photoluminescence (“PL”) spectra of the BaAl₂S₄:Eu bulk phosphor and the BaAl₂S₄:Eu nano-sized phosphor of Example 1 are shown in FIG. 7. Referring to FIG. 7, the BaAl₂S₄:Eu nano-sized phosphor of Example 1 has luminescent properties that are substantially similar to the BaAl₂S₄:Eu bulk phosphor as evidenced by the similarity in the maximum emission wavelength of the BaAl₂S₄:Eu nano-sized phosphor of Example 1 and the BaAl₂S₄:Eu bulk phosphor.

### Example 3

A mixture for forming a dielectric layer was prepared by combining 60 wt % of BaTiO₃ (Samsung Fine Chemical Ltd., SBT-03), 18 parts by weight of cyanoethylpullulan (Shin-Etsu, CRS), 82 parts by weight of dimethylformamide (“DMF”), and 12 parts by weight of chloroform. The mixture was spin-coated at 3000 revolutions per minute (“rpm”) on an ITO layer of a glass substrate (JMC, ITO glass 1.8 T Soda Lime) and was dried for 30 minutes at a temperature of 130° C. to form a first dielectric layer having a thickness of 3 μm.

Next, 15 parts by weight of a copolymer, (Shin-Etsu, CRM) formed by polymerizing monomers of cyanoethylpullulan and cyanoethyl polyvinyl alcohol, and 60 parts by weight of dimethylformamide (“DMF”) were mixed and stirred for 2 hours. Then, 25 parts by weight of the BaAl₂S₄:Eu nano-sized phosphor of Example 1 was mixed with the mixture, and zirconia beads (diameter=5 millimeters (mm)) were added. This combination was ball-milled to prepare a composition for forming an emitting layer.

The composition for forming a dielectric layer was spin-coated at a speed of 1000 rpm on the first dielectric layer, and then was dried for 30 minutes at a temperature of 130° C. to form an emitting layer having a thickness of 1 μm.

The composition for forming a dielectric layer was spin-coated at a speed of 300 rpm on the emitting layer, and then was dried for 30 minutes at a temperature of 130° C. to form a second dielectric layer having a thickness of 1 μm.

An Al electrode having a thickness of 200 nm was formed on the second dielectric layer by sputter deposition at a power of 80 watts (W) direct current (“DC”) to prepare an inorganic light-emitting device.

As described above, an embodiment of the nano-sized phosphor may be prepared by using a simple preparation method at low cost, and may have excellent luminescent properties while still having the same composition as that of a bulk phosphor. Thus, the nano-sized phosphor may be effectively used in an emitting layer of an inorganic light-emitting device, for example, an emitting layer of a dispersive inorganic light-emitting device.

It should be understood that the exemplary embodiments disclosed herein should be considered in a descriptive sense only and not for purposes of limitation. Descriptions of features, advantages, or aspects of each embodiment shall be considered as available for other similar features, advantages or aspects of other embodiments.

What is claimed is:

1. A nano-sized phosphor comprising:
sulfur,
wherein the nano-sized phosphor has a mean largest particle diameter of less than 1 micrometer.

2. The nano-sized phosphor of claim 1,
wherein a particle shape of the nano-sized phosphor comprises at least one shape selected from an oval shape, a triangular shape, a square shape, a circular shape, a peanut shape, and a spherical shape, and
wherein a largest protrusion of a surface of the nano-sized phosphor comprises a dimension which is less than 50% of the mean largest particle diameter of the nano-sized phosphor.

3. The nano-sized phosphor of claim 1, further comprising at least one element selected from europium and cerium.

4. The nano-sized phosphor of claim 1, comprising a composition represented by Formulas 1 or 2:
(M₁)(M₂)₂S₄:Eu Formula 1
(M₃)S:Ce Formula 2,
wherein, in Formulas 1 and 2,
M₁ and M₃ are each independently at least one element selected from beryllium, magnesium, calcium, strontium, barium, and radium, and
M₂ is at least one selected from boron, aluminum, gallium, indium, and thallium.

5. The nano-sized phosphor of claim 4, wherein the nano-sized phosphor is selected from BaAl₂S₄:Eu, SrGa₂S₄:Eu, and SrS:Ce.

6. An emitting layer comprising:
the nano-sized phosphor of claim 1; and
a binder.

7. An inorganic light-emitting device comprising:
a first electrode;
a dielectric layer;
an emitting layer comprising the nano-sized phosphor of claim 1 and a binder; and
a second electrode.

8. A method of preparing a nano-sized phosphor, the method comprising:
contacting a first phosphor comprising sulfur and a first solvent to prepare a first mixture;
pulverizing the first mixture to prepare a second mixture comprising a pulverized first phosphor and the first solvent;
removing the first solvent from the second mixture to obtain the pulverized first phosphor; and
heat-treating the pulverized first phosphor under a reducing atmosphere to prepare the nano-sized phosphor,
wherein
the nano-sized phosphor has a same composition as a composition of the first phosphor,
the nano-sized phosphor has a mean largest particle diameter of less than 1 micrometer, and
the nano-sized phosphor comprises sulfur.

9. The method of claim 8, wherein the first phosphor comprises a composition represented by Formulas 1 or 2:
(M₁)(M₂)₂S₄:Eu Formula 1
(M₃)S:Ce Formula 2,
wherein, in Formulas 1 and 2,
M₁ and M₃ are each independently at least one element selected from beryllium, magnesium, calcium, strontium, barium, and radium, and
M₂ is at least one element selected from boron, aluminum, gallium, indium, and thallium.

10. The method of claim 8, wherein the first solvent has a viscosity of about 2 milliPascal-seconds to about 12 milliPascal-seconds at a temperature of 25° C.

11. The method of claim 8, wherein the first solvent has an oxygen content of less than 20 weight percent, based on the molecular weight of the first solvent.

12. The method of claim 8, wherein the first solvent comprises a C₇ or higher linear or branched alcohol.

13. The method of claim 8, wherein the first solvent comprises at least one selected from 1-heptanol, 2-heptanol, 3-heptanol, 4-heptanol, 1-octanol, 2-octanol, 3-octanol, 4-octanol, 1-nonanol, 2-nonanol, 3-nonanol, 4-nonanol, 5-nonanol, 1-decanol, 2-decanol, 3-decanol, 4-decanol, and 5-decanol.

14. The method of claim 8, wherein the removing the first solvent comprises:
removing the first solvent by contacting the second mixture with a second solvent; and
removing the second solvent by freeze-drying.

15. The method of claim 14, wherein the second solvent comprises at least one solvent selected from ethanol and isopropyl alcohol. 16. The method of claim 8, wherein the removing the first solvent comprises freeze-drying for about 0.5 hours to about 24 hours at a temperature of about −20° C. to about −3° C.

17. The method of claim 8, wherein the heat-treating the pulverized first phosphor comprises heat-treating for about 0.5 hours to about 3 hours at a temperature of about 800° C. to about 1200° C.

18. The method of claim 8, wherein the reducing atmosphere comprises at least one selected from CS₂ gas, hydrogen gas, and nitrogen gas.

19. The method of claim 18, wherein the first phosphor is selected from BaAl₂S₄:Eu, SrGa₂S₄:Eu, and SrS:Ce.

20. A method of preparing an emitting layer, the method comprising:
providing a composition comprising:
a nano-sized phosphor comprising sulfur, wherein the nano-sized phosphor has a mean largest particle diameter of less than 1 micrometer,
a binder, and
a solvent;
disposing the composition on a substrate; and
heat-treating the composition on the substrate to prepare the emitting layer comprising the nano-sized phosphor and the binder.
